(19) United States
(12) Patent Application Publication
(10) Pub. No.: US 2025/0328601 A1
(43) Pub. Date: Oct. 23, 2025

(54) GRAPHICS PROCESSING UNIT (GPU) OPTIMIZATION USING DYNAMIC PROGRAMMING FOR GENERATIVE ARTIFICIAL INTELLIGENCE (AI) AND LARGE LANGUAGE MODELS (LLM)

(71) Applicant: Bank of America Corporation, Charlotte, NC (US)

(72) Inventors: Maharaj Mukherjee, Poughkeepsie, NY (US); Carl Benda, Charlotte, NC (US)

(21) Appl. No.: 18/637,902

(22) Filed: Apr. 17, 2024

(51) Int. Cl. G06F 17/16; G06F 1/03

(52) U.S. Cl. CPC G06F 17/16; G06F 1/03

(57) ABSTRACT

A computing platform may receive matrix multiplication information indicating a plurality of matrix dimension sets for matrix multiplication. For each matrix dimension set, the computing platform may: 1) identify one or more multiplication variations, indicating different possible orders of operation for executing the corresponding multiplication, 2) perform memoization to identify, for each order of operation, a corresponding number of operations to complete the corresponding multiplication, 3) identify, based on the numbers of operations, a most efficient order of operation, and 4) store, in a lookup table, a relationship between the given matrix dimension set and the most efficient order of operation. The computing platform may identify matrix dimensions for a model configuration request, and identify, using the lookup table, a corresponding order of operations. The computing platform may iteratively train the generative AI model based on the order of operations, and deploy the generative AI model.

### BACKGROUND

In some instances, the configuration of generative artificial intelligence (AI) and/or large language models (LLM) may be supported by graphics processing units (GPU). For example, due to the many different features incorporated into the initial training/configuration of such models, it may be difficult to train such models without the parallelization provided by such GPUs. It may be increasingly difficult, however, to obtain such GPUs due the limited number of semiconductors (e.g., which may be needed to support the GPUs) available. This problem may be exacerbated as larger models are developed, which may require an increased number of GPUs (which may, cause demand for such GPUs to exceed the supply).

### SUMMARY

Aspects of the disclosure provide effective, efficient, scalable, and convenient technical solutions that address and overcome the technical problems associated with developing and implementing computer hardware and software that leverages dynamic programming to optimize graphics processing units (GPU) for generative artificial intelligence (AI) and large language models (LLM). In accordance with one or more embodiments of the disclosure, a computing platform comprising at least one processor, a communication interface, and memory storing computer-readable instructions may receive matrix multiplication information indicating a plurality of matrix dimension sets for matrix multiplication. For each matrix dimension set, the computing platform may: 1) identify one or more multiplication variations, indicating different possible orders of operation for executing the corresponding multiplication, 2) perform memoization to identify, for each order of operation, a corresponding number of operations to complete the corresponding multiplication, 3) identify, based on the numbers of operations, a most efficient order of operation, and 4) store, in a lookup table, a relationship between the given matrix dimension set and the most efficient order of operation. The computing platform may receive a request to configure a generative artificial intelligence (AI) model. The computing platform may identify first matrix dimensions corresponding to the request. The computing platform may identify, using the lookup table, a first order of operations corresponding to the first matrix dimensions. The computing platform may iteratively train the generative AI model based on the first order of operations. The computing platform may deploy the generative AI model.

In one or more instances, each of the plurality of matrix dimension sets may define dimensions of at least two matrices to be multiplied. In one or more instances, identifying the one or more multiplication variations may include identifying every available multiplication operation that may be used to multiply the at least two matrices.

In one or more examples, identifying the most efficient order of operations may include selecting an order of operations that includes the smallest number of operations. In one or more examples, the computing platform may identify whether an entry in the lookup table includes the first matrix dimensions. Based on identifying that the lookup table does include the first matrix dimensions, the computing platform may select the first order of operations from the lookup table.

In one or more instances, based on identifying that the lookup table does not include the first matrix dimensions, the computing platform May 1) identify one or more multiplication variations, indicating different possible orders of operation for multiplying the first matrix dimensions, 2) perform memoization to identify, for each order of operation for multiplying the first matrix dimensions, a corresponding number of operations to complete the multiplication of the first matrix dimensions, 3) identify, based on the numbers of operations for the first matrix dimensions, a most efficient order of operations for the first matrix dimensions, 4) store, in the lookup table, a relationship between the first matrix dimensions and the most efficient order of operations for the first matrix dimensions, and 5) select the first order of operations from the lookup table.

In one or more examples, iteratively training the generative AI model based on the first order of operations may include executing, for each iteration, a multiplication of the first matrix dimensions according to the first order of operations to converge at a solution for the generative AI model. In one or more examples, the memoization may be performed by at least one graphics processing unit (GPU). In one or more examples, the memoization may be performed for multiple matrix dimension sets in parallel using the at least one GPU.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment configured to leverage dynamic programming to optimize GPUs for the configuration of generative AI and large language models in accordance with one or more example embodiments;

FIGS. 2A-2C depict an illustrative event sequence for leveraging dynamic programming to optimize GPUs for the configuration of generative AI and large language models in accordance with one or more example embodiments; and

FIG. 3 depicts an illustrative method for leveraging dynamic programming to optimize GPUs for the configuration of generative AI and large language models in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. In some instances, other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As a brief introduction to the concepts described further herein, one or more aspects of the disclosure relate to leveraging dynamic programming to optimize GPUs for the configuration of generative AI and large language models. For example, most computations using GPUs may involve matrix multiplication. Accordingly, described herein is a method to simplify the operations done in matrix multiplications, which may, e.g., consume less GPU. This operation may be performed by reordering the matrix multiplications so that the number of operations may be minimized. Dynamic programming may be used to minimize the number of matrix operations.

For example, determining the order of matrix multiplication using a brute force method may be an exponential time problem and may be very inefficient. A dynamic programming method on the other hand may store partially computed results, and may find the optimal ordering by combining partially computed results in polynomial time. Accordingly, in the proposed solution, given a set of matrices to be multiplied, optimal ordering may be identified using dynamic programming on the given GPU bank. The GPU bank may be used to perform the multiplication using the given ordering.

These and other features are described in further detail below.

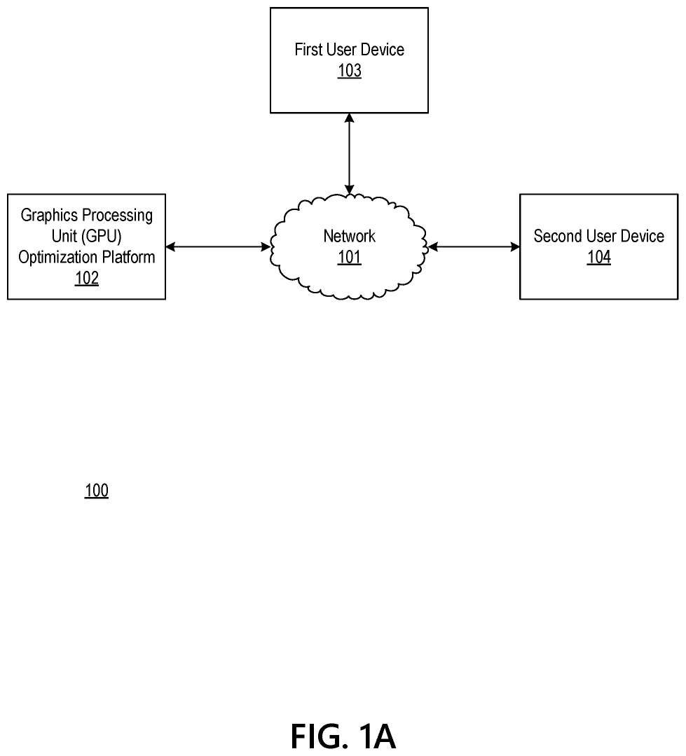

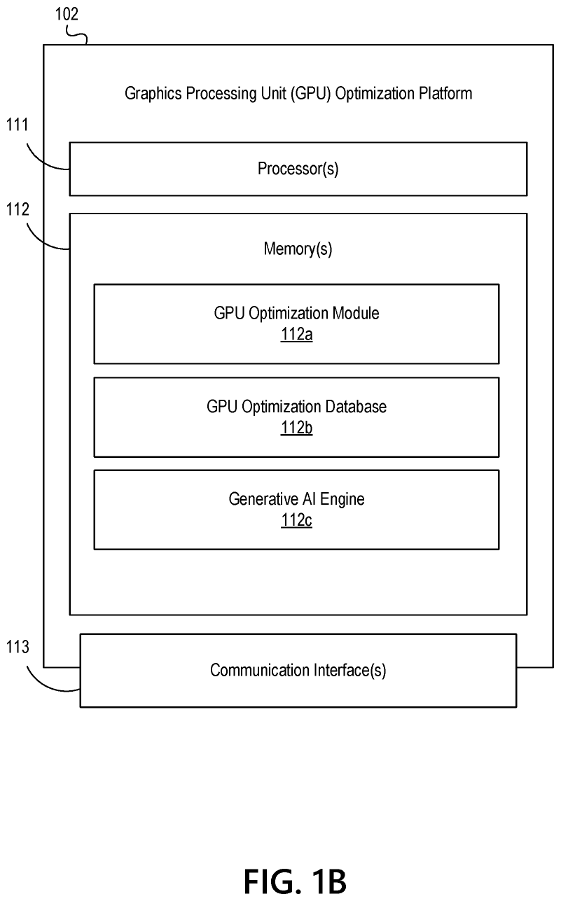

FIGS. 1A-1B depict an illustrative computing environment that leverages dynamic programming to optimize GPUs for the configuration of generative AI and large language models in accordance with one or more example embodiments. Referring to FIG. 1A, computing environment 100 may include one or more computer systems. For example, computing environment 100 may include graphics processing unit (GPU) optimization platform 102, first user device 103, and second user device 104.

Graphics processing unit (GPU) optimization platform 102 may be a computer system that includes one or more computing devices (e.g., servers, server blades, or the like) and/or other computer components (e.g., processors, memories, communication interfaces) that may be used to identify optimal ordering for performing matrix multiplication at one or more GPUs. In some instances, the GPU optimization platform 102 may be configured to store such optimal ordering in a table once identified. In some instances, the GPU optimization platform 102 may itself include the one or more GPUs. In other instances, the GPUs may be separate from the GPU optimization platform 102.

First user device 103 may be and/or otherwise include one or more devices such as a laptop computer, desktop computer, mobile device, tablet, smartphone, and/or other device that may be used by an individual to submit request to train and/or otherwise configure a generative AI model, LLM, and/or other model.

Second user device 104 may be and/or otherwise include one or more devices such as a laptop computer, desktop computer, mobile device, tablet, smartphone, and/or other device that may be used by an individual to submit request to train and/or otherwise configure a generative AI model, LLM, and/or other model. Although two user devices are shown, any number of such devices may be deployed in the systems/methods described below without departing from the scope of the disclosure.

Computing environment 100 also may include one or more networks, which may interconnect GPU optimization platform 102, first user device 103, and second user device 104. For example, computing environment 100 may include a network 101 (which may interconnect, e.g., GPU optimization platform 102, first user device 103, and second user device 104).

In one or more arrangements, GPU optimization platform 102, first user device 103, and second user device 104 may be any type of computing device capable of sending and/or receiving requests and processing the requests accordingly. For example, GPU optimization platform 102, first user device 103, second user device 104, and/or the other systems included in computing environment 100 may, in some instances, be and/or include server computers, desktop computers, laptop computers, tablet computers, smart phones, and/or other devices that may include one or more processors, memories, communication interfaces, storage devices, and/or other components. As noted above, and as illustrated in greater detail below, any and/or all of GPU optimization platform 102, first user device 103, and second user device 104 may, in some instances, be special-purpose computing devices configured to perform specific functions.

Referring to FIG. 1B, GPU optimization platform 102 may include one or more processors 111, memory 112, and communication interface 113. A data bus may interconnect processor 111, memory 112, and communication interface 113. Communication interface 113 may be a network interface configured to support communication between GPU optimization platform 102 and one or more networks (e.g., network 101, or the like). Memory 112 may include one or more program modules having instructions that when executed by processor 111 cause GPU optimization platform 102 to perform one or more functions described herein and/or one or more databases that may store and/or otherwise maintain information which may be used by such program modules and/or processor 111. In some instances, the one or more program modules and/or databases may be stored by and/or maintained in different memory units of GPU optimization platform 102 and/or by different computing devices that may form and/or otherwise make up GPU optimization platform 102. For example, memory 112 may have, host, store, and/or include GPU optimization module 112a, GPU optimization database 112b, and generative AI engine 112c.

GPU optimization module 112a may store and/or otherwise execute one or more instructions that may cause the GPU optimization platform 102 to execute advanced dynamic programming techniques to identify and/or otherwise perform optimal ordering for matrix multiplication. GPU optimization database 112b may stored one or more correlations between matrix multiplication dimensions and optimal ordering identified through the dynamic programming, which may, e.g., be used by the GPU optimization module 112a and/or GPU optimization platform 102 to perform matrix multiplication. Generative AI engine 112c may be configured to train, host, and/or otherwise refine one or more generative AI models, LLMs, and/or other models.

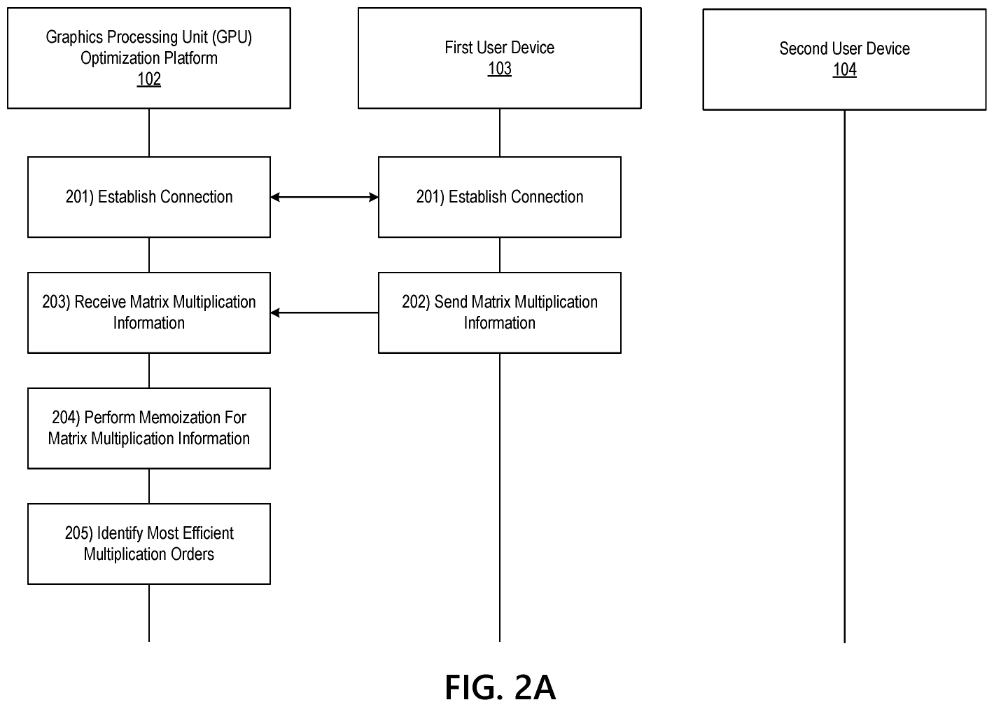

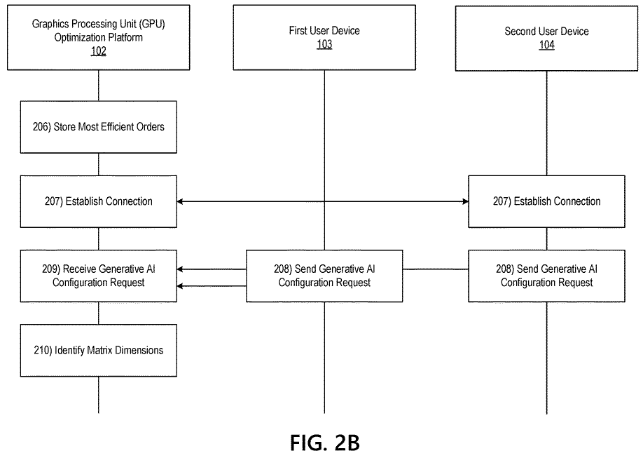

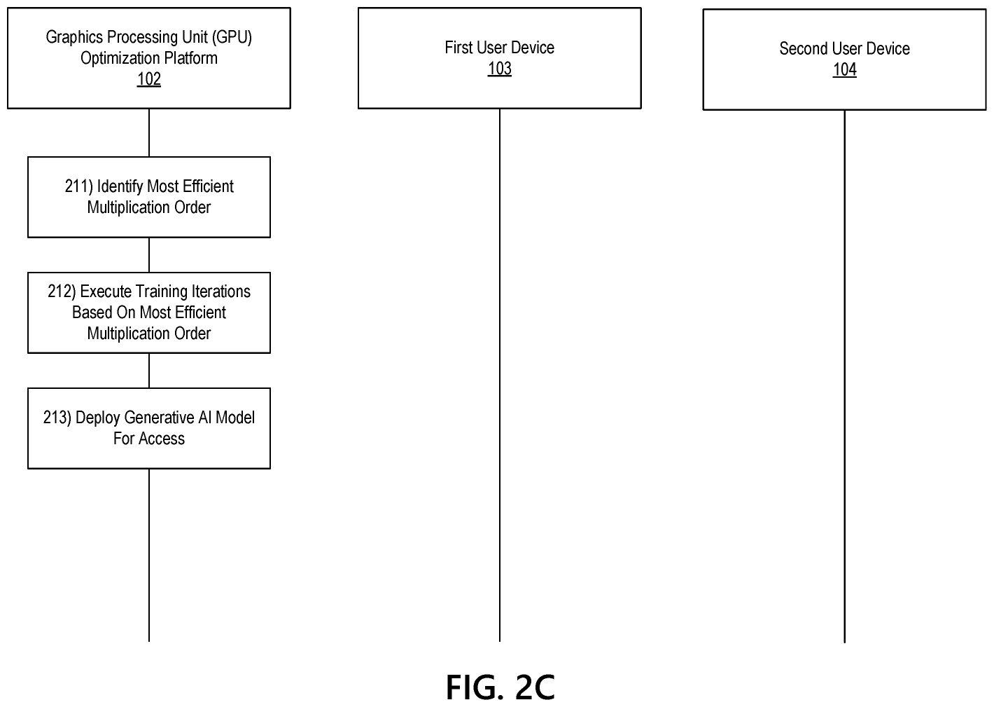

FIGS. 2A-2C depict an illustrative event sequence for leveraging dynamic programming to optimize GPUs for the configuration of generative AI and large language models in accordance with one or more example embodiments. Referring to FIG. 2A, at step 201, the first user device 103 may establish a connection with the GPU optimization platform 102. For example, the first user device 103 may establish a first wireless data connection with the GPU optimization platform 102 (e.g., in preparation for sending matrix multiplication information). In some instances, the first user device 103 may identify whether a connection is already established with the GPU optimization platform 102. If a connection is already established with the GPU optimization platform 102, the first user device 103 might not re-establish the connection. Otherwise, if a connection is not yet established with the GPU optimization platform 102, the first user device 103 may establish the first wireless data connection as described herein.

At step 202, the first user device 103 may send matrix multiplication information to the GPU optimization platform 102. For example, the first user device 103 may send a plurality of different matrix dimensions for which multiplication is anticipated (e.g., multiplication of a four by four matrix by another four by four matrix, or the like). In some instances, each set of matrix dimensions may define matrix dimensions of at least two matrices to be multiplied. In some instances, the first user device 103 may send the matrix multiplication information to the GPU optimization platform 102 while the first wireless data connection is established.

At step 203, the GPU optimization platform 102 may receive the matrix multiplication information sent at step 202. For example, the GPU optimization platform 102 may receive the matrix multiplication information via the communication interface 113 and while the first wireless data connection is established.

At step 204, the GPU optimization platform 102 may use dynamic programming (such as memoization, or the like) to identify, for each set of dimensions included in the matrix multiplication information, a number of operations corresponding to each of a plurality of different variations of the corresponding set of dimensions. For example, if the matrix multiplication information includes a 10×30 matrix “A,” a 30×5 matrix “B,” and a 5×60 matrix “C,” the GPU optimization platform 102 may identify that the corresponding multiplication may be performed according to either of the following orders: (AB)C, or A(BC). Then, for each variation, a number of operations may be identified. So, continuing with the same example, multiplying (AB)C would result in (10×30×5)+(10×5×60)=1500+3000=4500 operations, whereas multiplying A(BC) would result in (30×5×60)+(10×30×60)=9000+18000=27000 operations. The GPU optimization platform 102 may identify such numbers of operations for each variation of each set of dimensions to be multiplied. In doing so, the GPU optimization platform 102 may identify every available multiplication operation that may be used to multiply each corresponding set of matrix dimensions.

In some instances, the GPU optimization platform 102 may perform the dynamic programming (e.g., memoization, or the like) using at least one GPU, which may or might not be included in the GPU optimization platform 102. In some instances, the GPU optimization platform 102 may cause multiple different sets of matrix dimensions to be evaluated via memoization using the at least one GPU. For example, the GPU may analyze multiplication of a four by four matrix with another four by four matrix, in addition to multiplication of a four by four matrix by a five by five matrix. In some instances, the different dimensions may be analyzed by the GPU simultaneous, sequentially, in parallel, and/or otherwise. In some instances, the analysis may be performed at a single GPU or across multiple different GPUs.

At step 205, the GPU optimization platform 102 may identify a most efficient multiplication order for each set of dimensions to be multiplied. For example, although it might not affect the product, the order in which the terms are parenthesized affects the number of simple arithmetic operations needed to compute the product (e.g., the computational complexity), as is shown above. Thus, the number of ordinary multiplications may be used as a measure of runtime complexity. Accordingly, matrix multiplication may be most efficient where the number of operations is lowest. Thus, for each set of matrix dimensions to be multiplied, the GPU optimization platform 102 may select a multiplication order with the lowest number of operations (as determined above at step 204). For example, in the example of the ABC multiplication described above, the multiplication order of (AB)C may be selected because it may cause 4500 operations to be performed rather than the 27000 operations of A(BC).

Referring to FIG. 2B, at step 206, the GPU optimization platform 102 may select and store the most efficient multiplication order for each set of matrix dimensions to be multiplied. For example, continuing with the above example, the GPU optimization platform 102 may store a correlation between the dimensions of A, B, and C, and the multiplication order of (AB)C. In some instances, the GPU optimization platform 102 may also store the corresponding number of operations (e.g., 4500 in the case of (AB)C). In storing these correlations, the GPU optimization platform 102 may create and/or otherwise update a lookup table that includes the matrix dimensions, most efficient multiplication order, corresponding number of operations, and/or other information. In doing so, the GPU optimization platform 102 may generate a table that may be quickly referenced to identify, for a given set of matrix dimensions to be multiplied, a most efficient order for doing so.

By storing this information, the GPU optimization platform 102 may significantly reduce the computing power needed to perform multiplication of such matrices in the future, as it may avoid performing a duplicated effort of the memoization for a given set of dimensions, and furthermore, may cause the corresponding multiplication to be performed in a most efficient manner. In doing so, demand for the GPUs may be decreased, and thus performance of a limited amount of GPUs may be optimized (e.g., in terms of using as little of the GPUs as possible to perform a given task).

At step 207, the second user device 104 may establish a connection with the GPU optimization platform 102. For example, the second user device 104 may establish a second wireless data connection with the GPU optimization platform 102 to link the second user device 104 with the GPU optimization platform 102 (e.g., in preparation for sending generative AI configuration requests). In some instances, the second user device 104 may identify whether or not a connection is already established with the GPU optimization platform 102. If a connection is already established with the GPU optimization platform 102, the second user device 104 might not re-establish the connection. Otherwise, if a connection is not yet established with the GPU optimization platform 102, the second user device 104 may establish the second wireless data connection as described herein.

At step 208, the first user device 103 and/or the second user device 104 may send a request to configure, train, and/or otherwise refine a generative AI model, LLM, or the like. For example, in some instances, the first user device 103 and/or the second user device 104 may send the request while the first and/or second wireless data connection is established. In some instances, in sending the request, the first user device 103 and/or second user device 104 may send matrix dimensions to be multiplied (e.g., in each iteration of training the model, which may enable the model to converge on a final solution).

At step 209, the GPU optimization platform 102 may receive the generative AI configuration request sent at step 208. For example, the GPU optimization platform 102 may receive the generative AI configuration request via the communication interface 113 and while the first and/or second wireless data connection is established.

At step 210, the GPU optimization platform 102 may identify the matrix dimensions to be multiplied to perform the requested configuration. For example, the GPU optimization platform 102 may identify the matrix dimensions included within the generative AI configuration request, and/or may automatically identify the matrix dimensions based on other information included in the request (e.g., an intent or purpose of the model, a number of features to be considered, and/or other information).

Referring to FIG. 2C, at step 211, the GPU optimization platform 102, may identify, for the identified matrix dimensions to be multiplied, the most efficient multiplication order. For example, the GPU optimization platform 102 may identify, by performing a lookup function on the lookup table generated at step 206 and using the identified matrix dimensions as the input, the corresponding most efficient multiplication order.

In some instances, the GPU optimization platform 102 may identify that the identified matrix dimensions are not included in the lookup table. In these instances, the GPU optimization platform 102 may identify the most efficient multiplication order by performing actions similar to those described above with regard to steps 204 and 205. In these instances, once the most efficient multiplication order is identified, it may be stored in the lookup table (e.g., the lookup table may be dynamically updated to include newly identified matrix dimensions and the corresponding most efficient multiplication orders).

At step 212, the GPU optimization platform 102 may execute a plurality of training iterations to configure, train, and/or otherwise refined the requested generative AI model, LLM, or the like. In doing so, at each iteration, the GPU optimization platform 102 may perform matrix multiplication (e.g., multiplying matrices corresponding to the dimensions identified at step 210). To do so, the GPU optimization platform 102 may utilize the multiplication order identified at step 211. For example, the GPU optimization platform 102 may perform this multiplication at each iteration until the requested model has converged at a final solution.

In some instances, the GPU optimization platform 102 may use one or more GPUs to perform the training. In some instances, the GPU optimization platform 102 may use one or more GPUs to train multiple different models (e.g., a model requested by the first user device 103 and another model requested by the second user device 104) simultaneously, in sequence, in parallel, or the like. In these instances, the models may be trained by a single GPU, by different GPUs, and/or otherwise.

In some instances, in training the model, the GPU optimization platform 102 may use one or more techniques that learn a representation of training data, which may, e.g., be used to generate new content that is similar to or inspired by existing data. For example, the GPU optimization platform 102 may train the model (e.g., using deep learning, reinforcement learning, or the like) to generate content that may include human-like outputs, such as natural language text, source code, images/videos, audio samples, or the like. In some instances, the model may leverage open-source and/or vendor sourced models, and may be provisioned in one of a variety of ways, such as an application programming interface (API), search engine, chatbot, or the like. In some instances, usage of the model may be governed by enterprise AI policy, enterprise model risk policy, or the like. In some instances, in training the model, the GPU optimization platform 102 may train the model to generate human-like text, search and retrieve information, summarize text, perform classification, understand natural language and answer questions, analyze sentiment, filter content, translate language, assist with computer code, generate content for creative applications, and/or perform other tasks.

At step 213, the GPU optimization platform 102 may deploy the requested model for use (e.g., by the first user device 103, second user device 104, and/or other devices). For example, the GPU optimization platform 102 may deploy a generative AI model, LLM, and/or other model.

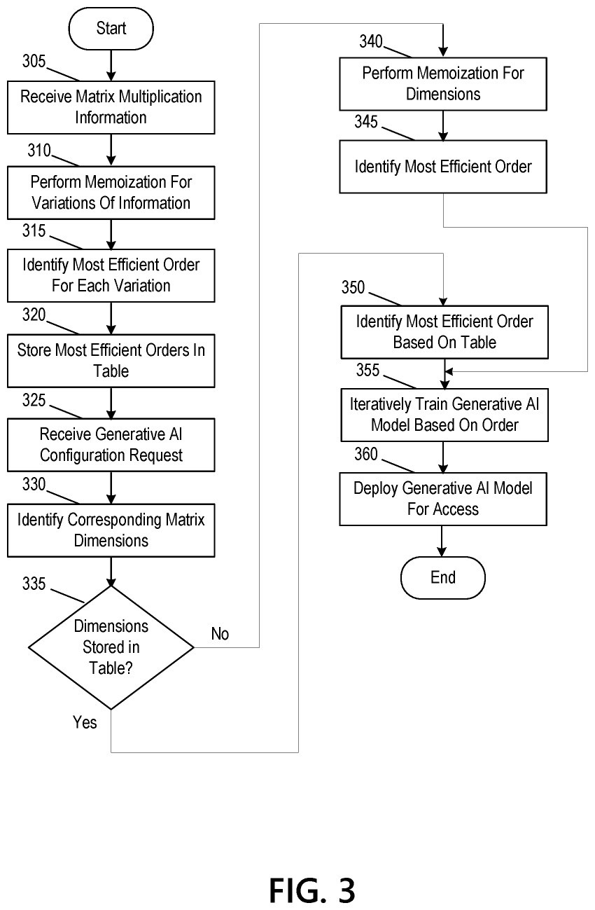

FIG. 3 depicts an illustrative method for leveraging dynamic programming to optimize GPUs for the configuration of generative AI and large language models in accordance with one or more example embodiments. Referring to FIG. 3, at step 305, a computing platform having at least one processor, a communication interface, and memory may receive matrix multiplication information. At step 310, the computing platform may perform memoization for variations of the matrix multiplication information to identify a number of operations for each variation. At step 315, the computing platform may identify a most efficient order for each variation based on the corresponding numbers of operations. At step 320, the computing platform may store the most efficient orders for each set of dimensions included in the matrix multiplication information in a lookup table. At step 325, the computing platform may receive a generative AI configuration request. At step 330, the computing platform may identify matrix dimensions corresponding to the generative AI configuration request. At step 335, the computing platform may identify whether or not the matrix dimensions are included in the lookup table. If the dimensions are not stored in the table, the computing platform may proceed to step 340.

At step 340, the computing platform may perform memoization for the dimensions to identify the corresponding number of operations for each multiplication variation corresponding to the dimensions. At step 345, the computing platform may identify the most efficient order based on the numbers of operations. At step 355, the computing platform may iteratively train the generative AI model by multiplying matrices corresponding to the identified matrix dimensions according to the most efficient order. At step 360, the computing platform may deploy the generative AI model for access.

Returning to step 335, if the computing platform identified that the dimensions were stored in the table, the computing platform may proceed to step 350. At step 350, the computing platform may identify the most efficient multiplication order based on the correlation identified in the table. The computing platform may then proceed to steps 355 and 360 to train and deploy the generative AI model as is described above.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, cause the computing platform to:
receive matrix multiplication information indicating a plurality of matrix dimension sets for matrix multiplication;
for each matrix dimension set:
identify one or more multiplication variations, indicating different possible orders of operation for executing the corresponding multiplication,
perform memoization to identify, for each order of operation, a corresponding number of operations to complete the corresponding multiplication,
identify, based on the numbers of operations, a most efficient order of operation, and
store, in a lookup table, a relationship between the given matrix dimension set and the most efficient order of operation;
receive a request to configure a generative artificial intelligence (AI) model;
identify first matrix dimensions corresponding to the request;
identify, using the lookup table, a first order of operations corresponding to the first matrix dimensions;
iteratively train the generative AI model based on the first order of operations; and
deploy the generative AI model.

2. The computing platform of claim 1, wherein each of the plurality of matrix dimension sets defines dimensions of at least two matrices to be multiplied.

3. The computing platform of claim 2, wherein identifying the one or more multiplication variations comprises identifying every available multiplication operation that may be used to multiply the at least two matrices.

4. The computing platform of claim 1, wherein identifying the most efficient order of operations comprises selecting an order of operations that includes the smallest number of operations.

5. The computing platform of claim 1, wherein the memory stores additional computer-readable instructions that, when executed by the at least one processor, cause the computing platform to:
identify whether an entry in the lookup table includes the first matrix dimensions; and
based on identifying that the lookup table does include the first matrix dimensions, select the first order of operations from the lookup table.

6. The computing platform of claim 5, wherein the memory stores additional computer-readable instructions that, when executed by the at least one processor, cause the computing platform to:
based on identifying that the lookup table does not include the first matrix dimensions:
identify one or more multiplication variations, indicating different possible orders of operation for multiplying the first matrix dimensions,
perform memoization to identify, for each order of operation for multiplying the first matrix dimensions, a corresponding number of operations to complete the multiplication of the first matrix dimensions,
identify, based on the numbers of operations for the first matrix dimensions, a most efficient order of operations for the first matrix dimensions,
store, in the lookup table, a relationship between the first matrix dimensions and the most efficient order of operations for the first matrix dimensions, and
select the first order of operations from the lookup table.

7. The computing platform of claim 1, wherein iteratively training the generative AI model based on the first order of operations comprises executing, for each iteration, a multiplication of the first matrix dimensions according to the first order of operations to converge at a solution for the generative AI model.

8. The computing platform of claim 1, wherein the memoization is performed by at least one graphics processing unit (GPU).

9. The computing platform of claim 8, wherein the memoization is performed for multiple matrix dimension sets in parallel using the at least one GPU.

10. A method comprising:
at a computing platform comprising at least one processor, a communication interface, and memory:
receiving matrix multiplication information indicating a plurality of matrix dimension sets for matrix multiplication;
for each matrix dimension set:
identifying one or more multiplication variations, indicating different possible orders of operation for executing the corresponding multiplication,
performing memoization to identify, for each order of operation, a corresponding number of operations to complete the corresponding multiplication,
identifying, based on the numbers of operations, a most efficient order of operation, and
storing, in a lookup table, a relationship between the given matrix dimension set and the most efficient order of operation;
receiving a request to configure a generative artificial intelligence (AI) model;
identifying first matrix dimensions corresponding to the request;
identifying, using the lookup table, a first order of operations corresponding to the first matrix dimensions;
iteratively training the generative AI model based on the first order of operations; and
deploying the generative AI model.

11. The method of claim 10, wherein each of the plurality of matrix dimension sets defines dimensions of at least two matrices to be multiplied.

12. The method of claim 11, wherein identifying the one or more multiplication variations comprises identifying every available multiplication operation that may be used to multiply the at least two matrices.

13. The method of claim 10, wherein identifying the most efficient order of operations comprises selecting an order of operations that includes the smallest number of operations.

14. The method of claim 10, further comprising:
identifying whether an entry in the lookup table includes the first matrix dimensions; and
based on identifying that the lookup table does include the first matrix dimensions, selecting the first order of operations from the lookup table.

15. The method of claim 14, further comprising:
based on identifying that the lookup table does not include the first matrix dimensions:
identifying one or more multiplication variations, indicating different possible orders of operation for multiplying the first matrix dimensions,
performing memoization to identify, for each order of operation for multiplying the first matrix dimensions, a corresponding number of operations to complete the multiplication of the first matrix dimensions,
identifying, based on the numbers of operations for the first matrix dimensions, a most efficient order of operations for the first matrix dimensions,
storing, in the lookup table, a relationship between the first matrix dimensions and the most efficient order of operations for the first matrix dimensions, and
selecting the first order of operations from the lookup table.

16. The method of claim 10, wherein iteratively training the generative AI model based on the first order of operations comprises executing, for each iteration, a multiplication of the first matrix dimensions according to the first order of operations to converge at a solution for the generative AI model.

17. The method of claim 10, wherein the memoization is performed by at least one graphics processing unit (GPU).

18. The method of claim 17, wherein the memoization is performed for multiple matrix dimension sets in parallel using the at least one GPU.

19. One or more non-transitory computer-readable media storing instructions that, when executed by a computing platform comprising at least one processor, a communication interface, and memory, cause the computing platform to:
receive matrix multiplication information indicating a plurality of matrix dimension sets for matrix multiplication;
for each matrix dimension set:
identify one or more multiplication variations, indicating different possible orders of operation for executing the corresponding multiplication,
perform memoization to identify, for each order of operation, a corresponding number of operations to complete the corresponding multiplication,
identify, based on the numbers of operations, a most efficient order of operation, and
store, in a lookup table, a relationship between the given matrix dimension set and the most efficient order of operation;
receive a request to configure a generative artificial intelligence (AI) model;
identify first matrix dimensions corresponding to the request;
identify, using the lookup table, a first order of operations corresponding to the first matrix dimensions;
iteratively train the generative AI model based on the first order of operations; and
deploy the generative AI model.

20. The one or more non-transitory computer-readable media of claim 19, wherein the memory stores additional instructions that, when executed by the at least one processor, cause the computing platform to:
wherein each of the plurality of matrix dimension sets defines dimensions of at least two matrices to be multiplied.
